(19) United States
(12) Patent Application Publication
(10) Pub. No.: US 2011/0031715 A1
(43) Pub. Date: Feb. 10, 2011

(54) BICYCLE TRANSMISSION WITH CLUTCH

(76) Inventor: Chin-Chin Lin, Taichung City (TW)

Correspondence Address: HDLS IPR Services, PO Box 220746, Chantilly, VA, 20153, US

(21) Appl. No.: 12/935,962

(22) PCT Filed: Apr. 17, 2009
(86) PCT No.: PCT/CN09/00413

§ 371 Date: Oct. 1, 2010

(30) Foreign Application Priority Data
Apr. 17, 2008 (CN) 200810089078.X

(51) Int. Cl. B62M 1/04

(52) U.S. Cl. 280/257; 280/253; 280/256

(57) ABSTRACT

A bicycle includes a frame, a pedaling device, a sprocket device, a stepping device and a clutch device. The pedaling device is furnished on the frame for a rider to perform pedaling operation. The sprocket device includes an axle pivotally coupled to the frame and a front sprocket rotatably mounted on the axle. The stepping device is connected between the pedal device and the sprocket device for transmitting power from the pedal device to rotate the axle and increasing moment of force of the pedaling operation by a reciprocal stepping operation. The clutch device is furnished on the frame for performing a first position to engage with the front sprocket so that the front sprocket is driven together with the axle by the stepping device to rotate, and a second position to disengage from the front sprocket so that the front sprocket is free from driven by the stepping device.

### BACKGROUND OF THE INVENTION

1. Technical Field

The invention generally relates to a bicycle, particularly to a bicycle transmission with clutch.

2. Related Art

Conventional transmission system of a bicycle drives the rear wheel to rotate by pedaling. As shown in FIG. 1, a crank 1 has one end coupled to a frame 2 and the other end coupled to a pedal 3. When a rider steps on the pedals 3, the crack 1 drives a front sprocket 4 to rotate and through a chain (not shown) connected between the front sprocket 4 and a rear sprocket 5 in turn to rotate the rear wheel 6. However, the moment of force provided by the conventional transmission system depends on the force stepped on the pedals and the arm of force, i.e. the length of the crank 1. Therefore, it may be labor-consuming and inefficient to perform the pedaling operation when riding the bicycle.

U.S. Pat. No. 7,753,387 discloses a bicycle stepping apparatus having a socket wrench coupled between the sprocket and the crank to increase the moment of force. However, the socket wrench is driven by the operation of the pedals. No matter the pedaling is clockwise or counter-clockwise, the socket wrench 30 is always operated to drive the rear wheel to rotate in one direction. That is, the bicycle may only be moved forward but not backward at riding, which is inconvenient for the rider.

### SUMMARY OF THE INVENTION

An object of the invention is to provide a bicycle transmission with clutch to increase moment of force for the pedaling operation and to perform a clutching operation.

Accordingly, the present invention is to provide a bicycle includes a frame and a transmission system. The transmission system includes a pedaling device, a sprocket device, a stepping device and a clutch device. The pedaling device includes a shaft, two cranks and two pedals. The shaft is pivotally couple to the frame, one end of each crank is fixedly connected to an end of the shaft, and each pedal is pivotally connected to the other end of the crank. The sprocket device includes an axle pivotally coupled to the frame and a front sprocket rotatably mounted on the axle. The axle has a first positioning portion formed on each of the two opposite ends and a second positioning portion, and the front sprocket has a plurality of radial cavities formed thereon. The stepping device includes two connectors, two unidirectional rotators and two linkage rod. Each connector has a receiving portion at one end for a pivot of the pedal engaged therein and a sliding portion formed with a pair of bearings at the other end. Each unidirectional rotator, such as a ratchet or a unidirectional bearing, which is allowed to rotate only in one direction, has a plurality of grooves formed at an inner axial surface thereof to engage with a plurality of teeth formed on each first positioning portion. Each linkage rod has one end to receive the sliding portion slid back and forth therein and the other end to connect the unidirectional rotator. As such, when the pedaling is performed by the pedal device, the ends of linkage rods connected to the connectors can move up and down due to the sliding portions respectively slide in the linkage rods and the unidirectional rotators are driven to rotate and in turn the axle is also driven to rotate. The clutch device includes a clutch element, a resilient element and a driving element. Similarly, a plurality of teeth are formed on the second positioning portion and the clutch element has a plurality of grooves formed in an inner axial surface thereof to engage with the teeth so that the clutch element is only slidable along an axial direction of the axle but not rotatable with respect to the axle. A protrusion is formed on one side of the clutch element adjacent to the front sprocket to engage with the cavity and a slot is formed on a circumference of the clutch element. The resilient element is mounted on the second positioning portion to have one end against on the axle and the other end against on the clutch element. The driving element includes a fixture fixedly mounted on the frame and a clamping portion secured in the slot. As such, under control of the rider, at a first position, the fixture pushes the clamping portion to drive the clutch element to engage with the front sprocket by having the protrusion located in the cavity, and at the second position, the fixture pulls the clamping portion to drive the clutch element to disengage from the front sprocket by having the protrusion located out of the cavity.

Moreover, the bicycle further includes a front wheel and a rear wheel pivotally connected on two distal ends of the frame, respectively. When the clutch device is at the first position, the rear wheel is driven through the front sprocket together with the axle by the stepping device to rotate, and when the clutch device is at the second position, the rear wheel is free from driven through the front sprocket together with the axle by the stepping device to rotate.

### BRIEF DESCRIPTION OF THE DRAWINGS

FIG. 1 shows a conventional bicycle transmission;

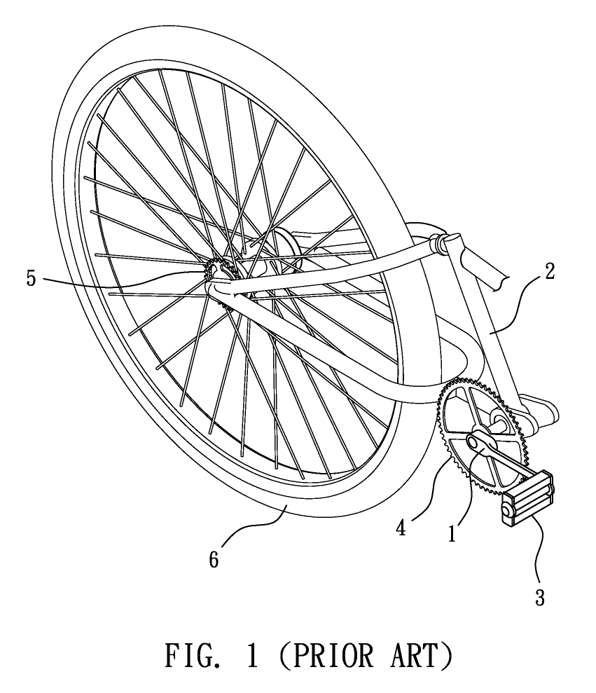

FIG. 2 shows a bicycle transmission with clutch according to the present invention;

FIG. 3 shows an operation of a stepping device according to the present invention;

FIG. 4 is a cross-sectional view of a clutch device at a first position according to the present invention;

FIG. 5 is a cross-sectional view of a clutch device at a second position according to the present invention; and

FIG. 6 is a cross-sectional view along an X-X line of FIG. 5 without showing the front sprocket.

### DETAILED DESCRIPTION OF THE INVENTION

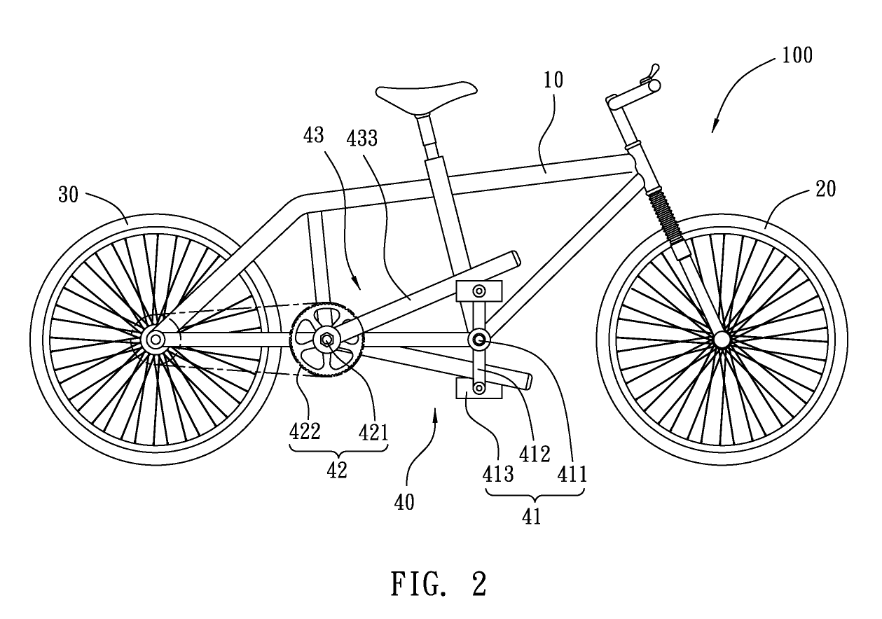

Please refer to FIGS. 2 to 5. A bicycle 100 of the present invention includes a frame 10, a front wheel 20, a rear wheel 30 and a transmission system 40. The frame 10 could be similar to any traditional bike frame. The front wheel 20 and the rear wheel 30 are pivotally connected on two distal ends of the frame 10, respectively. The transmission system 40 further includes a pedal device 41, a sprocket device 42, a stepping device 43 and a clutch device 44.

Referring to FIG. 2, the pedal device 41 is coupled to the frame 10 for a rider to perform pedaling. The pedal device 41 includes a shaft 411, two cranks 412 and two pedals 413. The shaft 411 is pivotally couple to the frame 10 and located between the front and the rear wheels 20 and 30. One end of each crank 412 is fixedly connected to a corresponding end of the shaft 411 and each pedal 413 is pivotally connected to the other end of the corresponding crank 412.

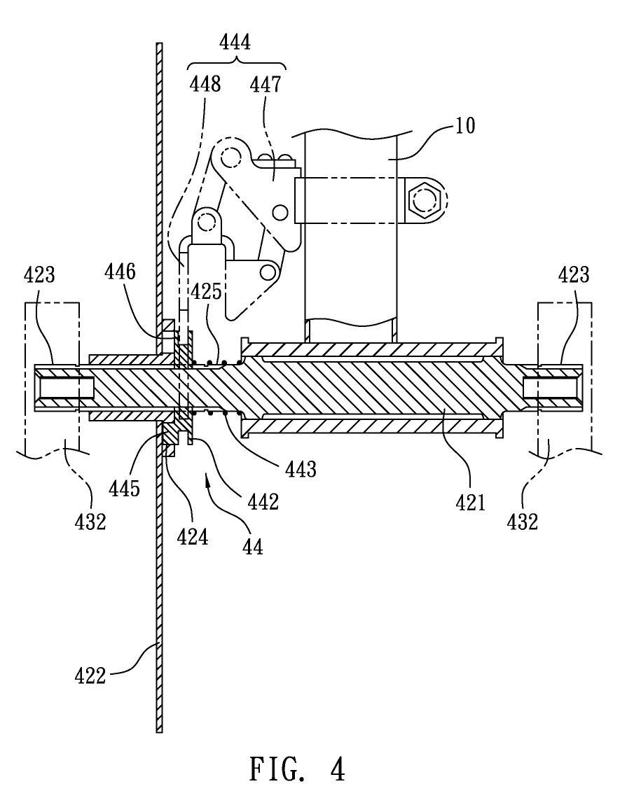

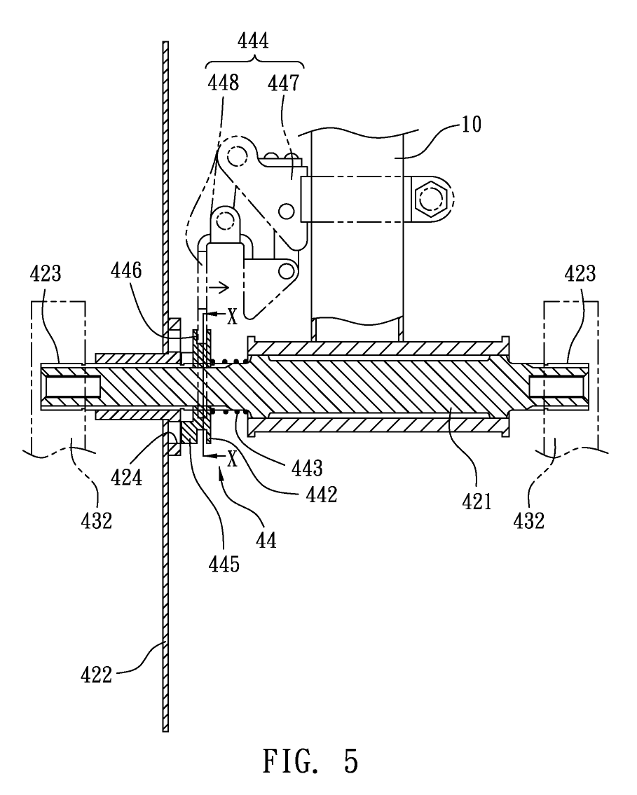

The sprocket device 42 is furnished on the frame 10 and capable of being driven to rotate. The sprocket device 42 includes an axle 421 coupled to the frame 10 and a front sprocket 422. The axle 421 has a first positioning portion 423 (see FIG. 4 or 5) formed on each of the two opposite ends thereof. Preferably, the first positioning portion 423 is formed with a plurality of teeth. The front sprocket 422 has an axle hole to mount on the axle 421 and is capable of being rotatable with respect to the axle 421. Still, there are a plurality of radial cavities 424 (see FIG. 4 or 5) formed on the front sprocket 422.

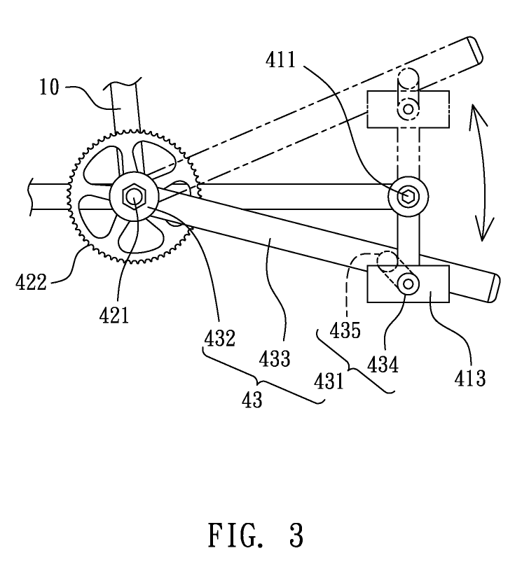

Referring to FIGS. 3 to 5, the stepping device 43 is coupled between the pedal device 41 and the sprocket device 42 to transmit pedaling power. The stepping device 43 includes two connectors 431, two unidirectional rotator 432 and two linkage rods 433. Each connector 431 has a receiving portion 434 at one end for a pivot of the pedal 413 engaged therein and a sliding portion 435 formed with a pair of bearings at the other end. Each unidirectional rotator 432, such as a ratchet or a unidirectional bearing, can be rotated only in one direction and has a plurality of grooves formed at the inner axial surface thereof to engage with the teeth of the corresponding first positioning portion 423 of the axle 421 so that the unidirectional rotator 432 could be driven to rotate the axle 421. Each linkage rod 433 has one distal end to receive the sliding portion 435 of the corresponding connector 431 slid back and forth therein and the other distal end to connect the corresponding unidirectional rotator 432. As such, when the pedaling is performed by the pedal device 41, the ends of linkage rods 433 connected to the connectors 431 move up and down due to the sliding portions 435 slide therein and the unidirectional rotators 432 are driven to rotate and in turn the axle 421 is also driven to rotate. By means of this arrangement, the moment of force performed by the pedaling is increased by a reciprocal stepping operation.

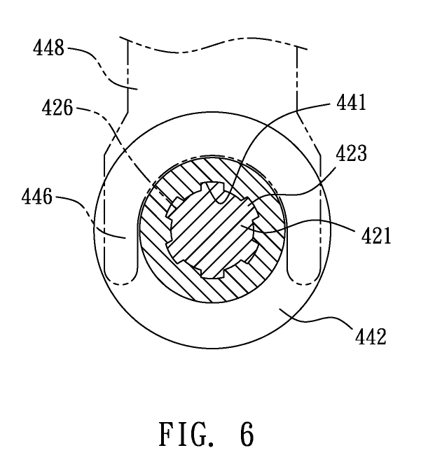

The clutch device 44 has a first position to engage with the front sprocket so that the front sprocket is driven together with the axle by the stepping device to rotate, and a second position to disengage from the front sprocket so that the front sprocket is free from driven together with the axle by the stepping device to rotate. The clutch device 44 includes a clutch element 442, a resilient element 443 and a driving element 444. The clutch element 442 has a ring-shaped body slidably furnished on a second positioning portion 425 of the axle 421 and a plurality of grooves 441 formed at the inner axial surface thereof to engage with the teeth 426 of the second positioning portion 425, as shown in FIG. 6; therefore, the clutch element 442 is only capable of sliding along an axial direction of the axle 421 but not capable of being rotated with respect to the axle 421. One side of the clutch element 442 adjacent to the front sprocket 422 is formed with a protrusion 445 to engage with the cavity 424 of the front sprocket 422. The clutch element 422 is also formed a slot 446 on the circumference thereof. The resilient element 443 is mounted on the second positioning portion 425 to have one end against on the axle 412 and the other end against on the clutch element 422. Therefore, the clutch element 422 could be more securely engaged with the front sprocket 422 by having the protrusion 445 located in the cavity 424 at the first position. The driving element 444 includes a fixture 447 fixedly mounted on the frame 10 and a clamping portion 448 secured in the ring slot 446 of the clutch element 442. As such, the rider can use wire control or electronic signal control to have the clutch device 44 at the first position or at the second position by controlling the fixture 447.

The operation of the bicycle 100 according to the present invention is as follows.

Referring to FIG. 4, the clutch device 44 is at the first position when normally riding the bicycle to move forward and driving the rear wheel 300 to rotate by pedaling. At this time, under the control of the rider, the fixture 447 pushes the clamping portion 448 to drive the clutch element 442 to engage with the front sprocket 422 by having the protrusion 445 located in the cavity 424. Therefore, the front sprocket 422 could be driven to rotate and through a chain (not shown) connected between the front sprocket 422 and a rear sprocket in turn to rotate the rear wheel 30.

On the other hand, referring to FIG. 5, the clutch device 44 is at the second position when not riding the bicycle but still capable of moving the bicycle forward and backward. At this time, under the control of the rider, the fixture 447 pulls the clamping portion 448 to drive the clutch element 442 to disengage from the front sprocket 422 by having the protrusion 445 located out of the cavity 424. Therefore, the front sprocket 422 is no more driven by the axle 421 to rotate.

While the forgoing is directed to a preferred embodiment of the present invention, other and further embodiments of the invention may be devised without departing from the basic scope thereof. As such, the appropriate scope of the invention is to be determined according to the claims.

What is claimed is:

1. A bicycle comprising:
a frame; and
a transmission system including:
a pedaling device furnished on the frame, adapted for a rider to perform pedaling operation;
a sprocket device including an axle and a front sprocket, the axle being pivotally coupled to the frame and the front sprocket mounted on the axle being rotatable with respect to the axle;
a stepping device connected between the pedal device and the sprocket device, adapted for transmitting pedaling power from the pedal device to rotate the axle of the sprocket device and increasing moment of force of the pedaling operation by a reciprocal stepping operation; and
a clutch device furnished on the frame, adapted for performing a first position to engage with the front sprocket so that the front sprocket is driven together with the axle by the stepping device to rotate, and a second position to disengage from the front sprocket so that the front sprocket is free from driven together with the axle by the stepping device to rotate.

2. The bicycle of claim 1, further comprising a front wheel and a rear wheel pivotally connected on two distal ends of the frame, respectively, when the clutch device is at the first position, the rear wheel is driven through the front sprocket together with the axle by the stepping device to rotate, and when the clutch device is at the second position, the rear wheel is free from driven through the front sprocket together with the axle by the stepping device to rotate.

3. The bicycle of claim 1, wherein the pedal device includes a shaft, two cranks and two pedals, the shaft is pivotally couple to the frame, one end of each crank is fixedly connected to an end of the shaft, and each pedal is pivotally connected to the other end of the crank.

4. The bicycle of claim 1, wherein the stepping device includes two connectors, two unidirectional rotators and two linkage rods, each connector has a receiving portion at one end for a pivot of the pedal engaged therein and a sliding portion formed with a pair of bearings at the other end, each unidirectional rotator engages with one end of the axle, and each linkage rod has one end to receive the sliding portion slid back and forth therein and the other end to connect the unidirectional rotator, so that when the pedaling is performed by the pedal device, the ends of linkage rods connected to the connectors move up and down due to the sliding portions respectively slide in linkage rods and the unidirectional rotators are driven to rotate and in turn the axle is also driven to rotate.

5. The bicycle of claim 4, wherein the axle has a positioning portion formed on each of the two opposite ends, and the two unidirectional rotators engage with the positioning portions, respectively.

6. The bicycle of claim 5, wherein the positioning portion is formed with a plurality of teeth and the unidirectional rotator has a plurality of grooves formed at an inner axial surface thereof to engage with the teeth.

7. The bicycle of claim 4, wherein the unidirectional rotator is a ratchet or a unidirectional bearing to rotate only in one direction.

8. The bicycle of claim 1, wherein a plurality of radial cavities are formed on the front sprocket, and the clutch device includes a clutch element and a driving element, the clutch element being slidably mounted on the axle but not rotatable with respect to the axle, a protrusion being formed on one side of the clutch element adjacent to the front sprocket to engage with the cavity and a slot being formed on a circumference of the clutch element, the driving element including a fixture fixedly mounted on the frame and a clamping portion secured in the slot, so that, under control of the rider, at the first position, the fixture pushes the clamping portion to drive the clutch element to engage with the front sprocket by having the protrusion located in the cavity, and at the second position, the fixture pulls the clamping portion to drive the clutch element to disengage with the front sprocket by having the protrusion located out of the cavity.

9. The bicycle of claim 7, wherein the axle has a positioning portion and the clutch device further includes a resilient element mounted on the positioning portion to have one end against on the axle and the other end against on the clutch element, so that at the first position, the clutch element could securely engage with the front sprocket by having the protrusion located in the cavity.

10. The bicycle of claim 7, wherein the axle has a positioning portion formed with a plurality of teeth thereon and the clutch element has a plurality of grooves formed in an inner axial surface thereof to engage with the teeth so that the clutch element is only slidable along an axial direction of the axle but not rotatable with respect to the axle.
